(19) United States
(12) Patent Application Publication
(10) Pub. No.: US 2022/0007796 A1
(43) Pub. Date: Jan. 13, 2022

(54) SANI-WATCH

(71) Applicants: Ravindra R. Jadhav, Oceanside, CA (US); Rupa Holenchi, Oceanside, CA (US)

(72) Inventors: Ravindra R. Jadhav, Oceanside, CA (US); Rupa Holenchi, Oceanside, CA (US)

(21) Appl. No.: 16/927,879

(22) Filed: Jul. 13, 2020

(51) Int. Cl. A44C 5/00; G04B 37/12; A47K 5/12

(52) U.S. Cl. CPC A44C 5/003; A47K 5/1201; A47K 5/1217; G04B 37/127

(57) ABSTRACT

An article of manufacture for a wearable watch and anti-bacterial fluid dispenser is disclosed. The wearable watch and anti-bacterial fluid dispenser includes a watch-dispenser case having a pair of watch bands 102a-b attached to either side of the case. The wearable watch and anti-bacterial fluid dispenser is to be worn on a wrist of the user in an ordinary way. The watch-dispenser case includes an electronic clock assembly and a fluid dispenser cavity with a removable cap covering a dispensing opening. The removable cap may be tethered to the watch dispenser case in order to prevent loss of the cap. The fluid dispenser cavity may be transparent or translucent in order for the user to easily view the remaining fluid within the fluid dispenser cavity.

### TECHNICAL FIELD

This application relates in general to an article of manufacture for providing a personal protection device, and more specifically, to an article of manufacture for a wearable watch and anti-microbial fluid dispenser.

### BACKGROUND

Individuals encounter many potential health dangers whenever they go out in public. Contact with other individuals and items that have been previously handled by other individuals may result in the transfer of bacteria, viruses, and similar pathogens from one individual to another. One possible defense against the possible transfer of these pathogens is to routinely and frequently wash one's hands with soap and water. When soap and water is not available, individuals may utilize anti-bacterial and anti-microbial fluids to wash possible threats to ones health from the hands.

Being able to have such anti-bacterial, anti-microbial fluids, or similar protective fluids on one's person may present a challenge to many people. Having to carry a bottle of such fluids and have it available at all times presents obstacles that may not always be easily overcome and is may require individuals to carry a bag or overload one's pockets to ensure it is with them.

Therefore, a need exists for an article of manufacture for a wearable watch and anti-bacterial fluid dispenser. By including an anti-bacterial, anti-microbial, and similar fluid dispenser within an item that is typically worn at all times while individuals are in public overcomes the above obstacles. Having such a dispenser on an individual's wrist makes is easy for them to dispense the fluid whenever needed. The present invention attempts to address the deficiencies of existing solutions using the principles of embodiments disclosed herein.

### SUMMARY

In accordance with the present invention, the above and other problems are solved by providing an article of manufacture a wearable watch and anti-bacterial fluid dispenser according to the principles and example embodiments disclosed herein.

In one embodiment, the present invention is an article of manufacture for a wearable watch and anti-bacterial fluid dispenser. The wearable watch and anti-bacterial fluid dispenser includes a watch-dispenser case having a pair of watch bands 102a-b attached to either side of the case. The wearable watch and anti-bacterial fluid dispenser is to be worn on a wrist of the user in an ordinary way. The watch-dispenser case includes an electronic clock assembly and a fluid dispenser cavity with a removable cap covering a dispensing opening. The removable cap may be tethered to the watch dispenser case in order to prevent loss of the cap. The fluid dispenser cavity may be transparent or translucent in order for the user to easily view the remaining fluid within the fluid dispenser cavity.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIGS. 1a-c illustrate example embodiments of an article of manufacture for a wearable watch and anti-bacterial fluid dispenser according to the present invention.

FIGS. 2a-d illustrate example embodiments of casings used in an article of manufacture for a wearable watch and anti-bacterial fluid dispenser according to the present invention.

FIG. 3 illustrates an example embodiment of a fluid dispenser opening for an article of manufacture for a wearable watch and anti-bacterial fluid dispenser according to the present invention.

FIGS. 4a-d illustrate an example embodiment of a funnel for use in filling an article of manufacture for a wearable watch and anti-bacterial fluid dispenser according to the present invention.

FIG. 5 illustrates multiple elevation views of an article of manufacture for a wearable watch and anti-bacterial fluid dispenser according to the present invention.

### DETAILED DESCRIPTION

This application relates in general to a system and method for providing a personal protection device, and more specifically, to an article of manufacture for a wearable watch and anti-bacterial fluid dispenser according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The terms “person,” and “user” refer to an entity, e.g. a human, using the article of manufacture for a wearable watch and anti-bacterial fluid dispenser associated with the invention. The term user herein refers to one or more users.

The term “invention” or “present invention” refers to the invention being applied for via the patent application with the title “Sani-Watch.” Invention may be used interchangeably with sani-watch, wearable watch, and watch.

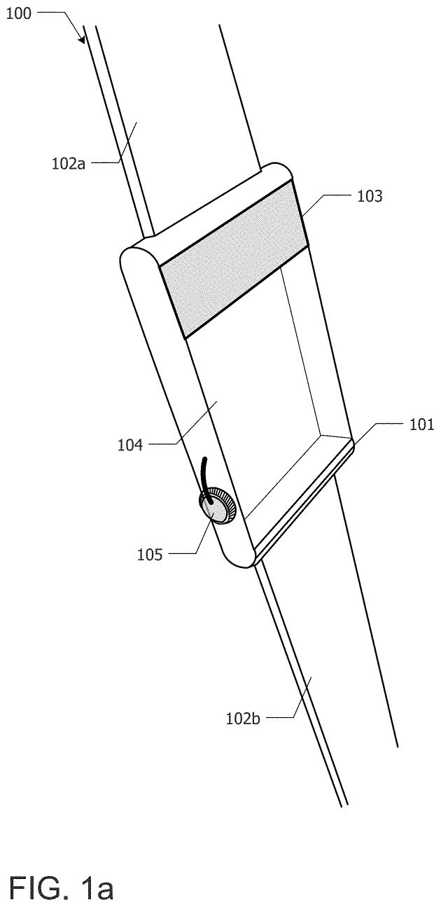

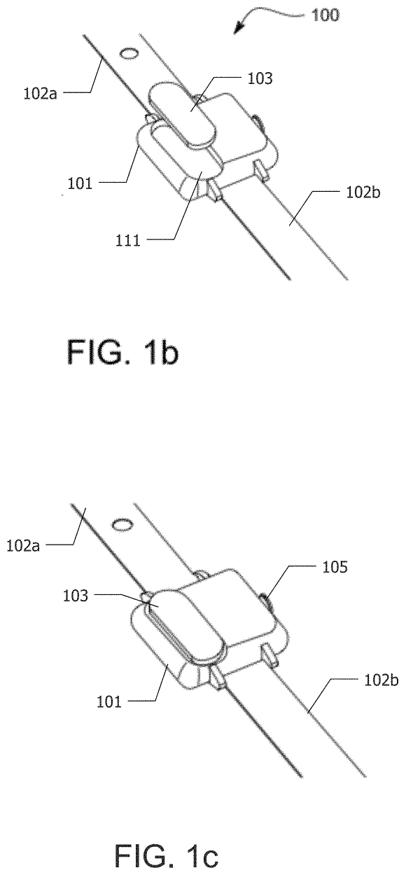

In general, the present disclosure relates to an article of manufacture for providing an all-in-one personal protection device. To better understand the present invention, FIGS. 1a-c illustrate example embodiments of an article of manufacture for a wearable watch and anti-bacterial fluid dispenser according to the present invention. The wearable watch and anti-bacterial fluid dispenser 100, as shown in FIG. 1a, comprises a watch-dispenser case 101 having a pair of watch bands 102a-b attached to either side of the case. The wearable watch and anti-bacterial fluid dispenser 100 is to be worn on a wrist of the user in an ordinary way. The watch-dispenser case 101 may also be utilized to dispense any type of fluid example sunscreen lotion, body lotion, first aid liquids etc. and may also carry small medication pills.

The watch-dispenser case 101 comprises an electronic clock assembly 103 and a fluid dispenser cavity 104 with a removable cap 105 covering a dispensing opening (not shown). The electronic clock assembly 103 may present a digital watch or may include a smart watch that connects to a smartphone and/or a cellular network. The removable cap 104 may be tethered to the watch dispenser case 101 in order to prevent loss of the cap 105. The fluid dispenser cavity 104 may be transparent or translucent in order for the user to easily view the remaining fluid within the fluid dispenser cavity 104.

A user may refill the fluid dispenser cavity 104, which may also be referred to as a sani-tank, with anti-bacterial or anti-microbial fluid that may be acquired in a larger container to carry on the person enough fluid for use during a single day. The fluid dispenser cavity 104 may be refilled as many times as desired. The user may simply remove the removable cap 105 and pour a small amount of the anti-bacterial fluid onto his or her opposite hand before replacing the removable cap 105 and rubbing the fluid about their hands until the fluid dries.

The electronic clock assembly 103 may be a battery-powered clock that shows the date and time on a display that is located on a top surface of the electronic clock assembly. The battery may be either disposable or rechargeable as desired. The date and time data may be organized and presented in any desired arrangement that may be constant or changeable by the user. Depending upon the size of the display that is art of the electronic clock assembly 103, a display may present any computer generated image or message.

The entire electronic clock assembly 103 may be removed from the watch-dispenser case 102 to gain access to components to set the date and time as well as replace or recharge an internal battery. The electronic clock assembly 103 matches a clock opening 111 in the watch-dispenser case 102 that permits the clock assembly to be inserted into the opening for use and removed as needed. The electronic clock assembly 103 may be sized to utilize any particular portion of the volume within the watch-dispenser case 102 with the realization that the volume of the fluid dispenser cavity 103 will reduce in size as the electronic clock assembly 103 increases.

FIG. 1b shows the electronic clock assembly 103 while it is outside of the opening 111 that may be inserted back into the watch-dispenser case 102 before the watch 100 is put onto the user's wrist. FIG. 1c shows the electronic clock assembly 103 after it has been reinserted into the clock opening 111 in the watch-dispenser case 102. The removable cap 105, which may also be referred to as a flip-top cap, is shown on an opposite surface of the watch-dispenser case 102 from the electronic clock assembly 102. The pair of watch bands 102a-b may be attached to the opposite sides of the watch-dispenser case 102 using ordinary watchband components.

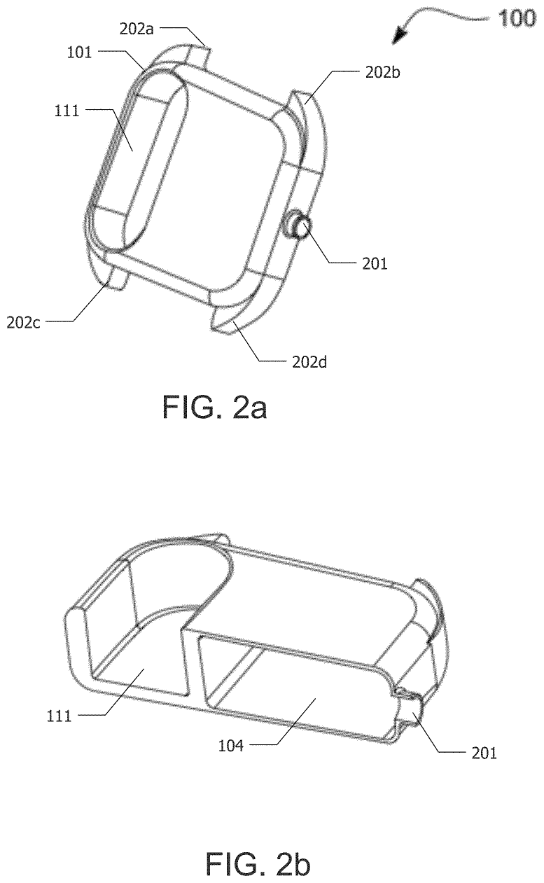

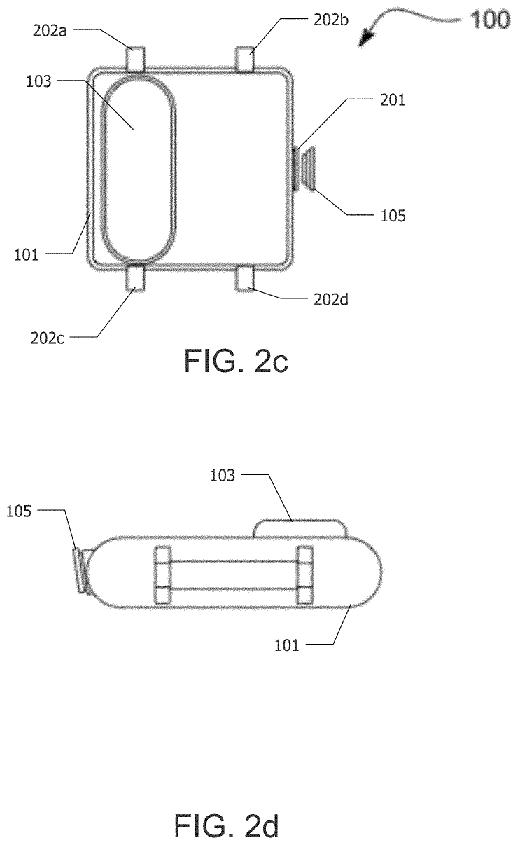

FIGS. 2a-d illustrate example embodiments of casings used in an article of manufacture for a wearable watch and anti-bacterial fluid dispenser according to the present invention. FIG. 2a shows a perspective top view of the watch-dispenser case 101. A square watch dispenser case 101 is a preferred embodiment that is sized to be a typical watch having case dimensions between 45-60 mm. A fluid dispensing opening 201 is shown on a side surface of the watch-dispenser case 101 that does not have a watchband 102a-b attached. One side of the watch-dispenser case 101 contains the fluid dispensing opening 201 coupled to the dispenser cavity 104 where the dispensing opening 201 corresponds to a through hole in the side of the watch-dispenser case 102. The clock opening 111 is typically located along the opposite side of the watch-dispenser case 102 from the fluid dispensing opening 201. Watchband attachment bevels 202a-d are shown on the sides of the watch-dispenser case 102 where the pair of watchbands 102a-b are attached.

FIG. 2b shows a cross section view of the watch-dispenser case 101. The dispenser cavity 104 along with the fluid dispensing opening 201 are shown as a closed container consuming a majority of the internal volume of the watch dispenser case 102. The clock opening 111 is shown as an open cavity into which the electronic clock assembly 103 may be inserted. In a preferred embodiment, the electronic clock assembly 103 is held in place in the watch-dispenser case 101 using friction. In other embodiments, other restraining mechanisms may also be utilized.

FIG. 2c shows a top down view of the watch-dispenser case 101. The electronic clock assembly 103 is shown installed into the watch-dispenser case 101. The removable cap 105 is shown about the fluid dispensing opening 201 on one side of the watch-dispenser case 101. The watchband attachment bevels 202a-d are shown on the sides of the watch-dispenser case 102 where the pair of watchbands 102a-b are attached.

FIG. 2d shows a side view of the watch-dispenser case 101. The electronic clock assembly 103 is shown installed into the watch-dispenser case 101 extending about a top surface of the case. The removable cap 105 is shown attached to the fluid dispensing opening 201 on one side of the watch-dispenser case 101. A pair of watchband attachment bevels 202a-b are shown on the side of the watch-dispenser case 102 where one of the watchbands 102a-b is attached.

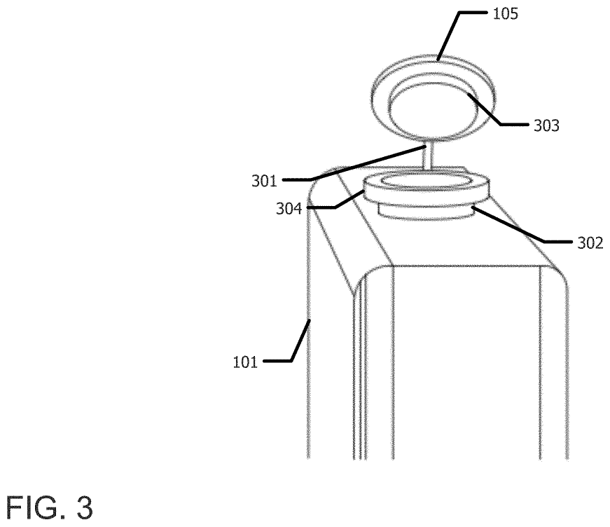

FIG. 3 illustrates an example embodiment of a fluid dispenser opening for an article of manufacture for a wearable watch and anti-bacterial fluid dispenser according to the present invention. The fluid dispensing opening 201 is shown along one side of the watch-dispenser case 101. The removable cap 105 is shown above the fluid dispensing opening 201 while being held in place by a tether 301. The fluid dispensing opening 201 may include a raised lip 302 that extends above the side of the watch-dispenser case 101. The raised lip 302 has an inner diameter that mates with a sealing plug 303 located on a bottom surface of the removable cap 105. The sealing plug 303 is sized to be tightly inserted into the inner diameter 305 of the raised lip 302. The sealing plug 303 being inserted into the inner diameter 305 of the raised plug 303 forms a leak-proof seal that prevents any fluid from inside the dispenser cavity 104 from leaving the fluid dispensing opening 201 as shown in above discussed figures.

In a preferred embodiment, the watch-dispenser case 101 is 13 mm wide. The raised lip 302 of the fluid dispensing opening 201 has an outer diameter of 8 mm and an inner diameter of 6 mm. The raised lip 302 may be 1 mm thick and may be raised 1 mm above the side of the watch-dispenser case 101. The diameter of the sealing plug 303 is 6 mm to match the inner diameter of the raised lip 302.

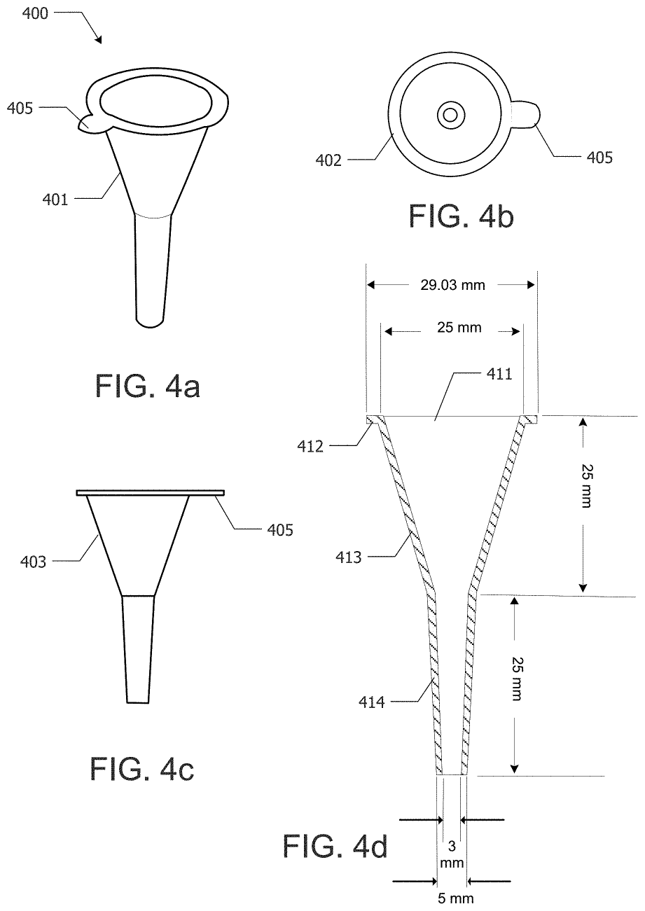

FIGS. 4a-d illustrate an example embodiment of a funnel for use in filling an article of manufacture for a wearable watch and anti-bacterial fluid dispenser according to the present invention. The fluid dispensing opening 201 may be no larger than the width of the watch-dispenser case 101. As such, a refilling funnel 400 may be inserted into the inner diameter 305 of the raised lip 302 to aid the user in pouring replacement fluid into the dispenser cavity 104. FIG. 4a shows a perspective view of the refilling funnel 400. FIG. 4b shows a top down view of the refilling funnel 400. A side view of the refilling funnel is shown in FIG. 4c. A holding tab 401 is shown along a top edge of the refilling funnel 400 to aid in its insertion and removal from the inner diameter 305 of the raised lip 302 and the fluid dispensing opening 201.

FIG. 4d shows a cross section side view of the refilling funnel 400 for a preferred embodiment of an article of manufacture for a wearable watch and anti-bacterial fluid dispenser. A large opening 411 that is 25 mm wide is located at the top of the refilling funnel 400. A top outside lip 412 surrounds the large opening 411. The overall width of the top outside lip 412 may be 20.03 mm.

In the preferred embodiment, the refilling funnel 400 may be 50 mm in length in which a narrowing top section 413 is 25 mm in length from the large opening 411 to a beginning of a funnel neck 414. The funnel neck 414 may also be 25 mm in length. The funnel neck 414 may have an inner diameter of 3 mm. The refilling funnel 400 may be made of 1 mm thick material, such as plastic, metal or similar rigid and reusable material. The refilling funnel 400 has an outer diameter of 5 mm that must be less than or equal to the inner diameter 305 of the raised lip 302 into the fluid dispensing opening 201.

One of ordinary skill in the art will recognize that the above dimensions may be varied as needed so long as the relationship between the refilling funnel 400 and the fluid dispensing opening 201 is maintained. The inner diameter of the funnel neck 414 should also be wide enough to permit the anti-bacterial fluid to easily pass into the dispenser cavity 104 without clogging.

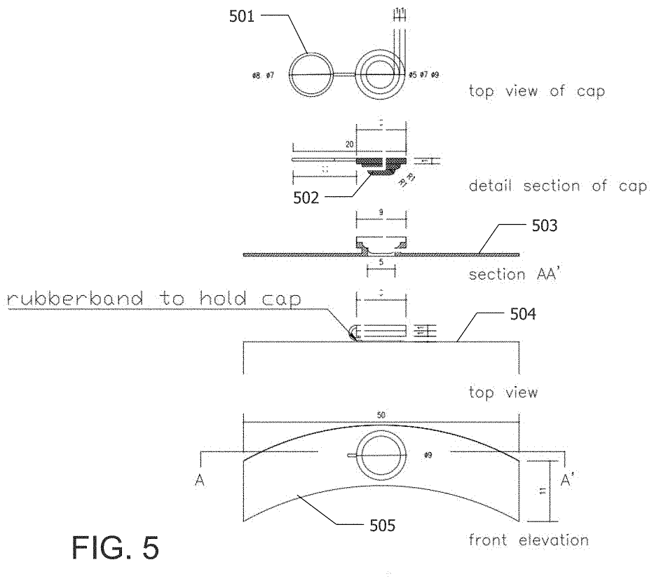

FIG. 5 illustrates multiple elevation views of an article of manufacture for a wearable watch and anti-bacterial fluid dispenser according to the present invention. A top view 501, as well as a cross section 502, of the removable cap 105 and tether is shown with dimensions of a preferred embodiment. A top view 503 of the watch-dispenser case 101 and a cross section of the case 504 through the fluid dispensing opening 201 is also shown with dimensions of a preferred embodiment. A side view 505 of the watch-dispenser case 101 and the fluid dispensing opening 201 is shown with the case 101 being curved to match the contours of a user's wrist.

The shape and sizes of the present invention, including the watch-dispenser case 101, the fluid dispenser cavity 104, the electronic clock assembly 103, the removable cap 105, and the pair of watch bands 102a-b as shown in the figures and disclosed herein are intended as examples of possible embodiments. The shape, sizes, and arrangement of the components of the present invention are to be limited only using the limitations recited within the attached claims. For example, the watch-dispenser case 101 may be shaped to represent an animal, such as a teddy bear, and to represent treats, such as various types of cookies, stars, sea creatures, cartoon characters and the like, to make the sani-watch 100 appealable to children. The size of the watch-dispenser case 101 may also be reduced to better fit a child's wrist. In some embodiments, the electronic clock assembly 103 may be omitted entirely.

Additionally, the present invention as implemented for use by children in some embodiments, may contain other useful items to children. For example, the watch-dispenser case 101 may be used as sani-stick container that includes a sticking glue on the back of the container. Similar to mobile phone sockets on the back of the mobile phone or on the any flat surface available. All of these additional embodiments are possible for a present invention defined by the limitations recited in the attached claims.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed:

1. An article of manufacture for a wearable watch and anti-bacterial fluid dispenser, the article comprises:
a wearable container case having a fluid dispenser cavity and a removable cap;
a pair of device bands for coupling to each other around a wrist, the pair of device bands being coupled to opposing sides of the wearable container case;
a replaceable useful item; and
an opening within the wearable container case for accepting insertion of the replaceable useful item.

2. The article of manufacture according to claim 1, wherein the replaceable item comprises a battery powered electronic watch assembly.

3. The article of manufacture according to claim 1, wherein the fluid dispenser cavity holds a useful fluid comprising an anti-bacterial and an anti-microbial fluid.

4. The article of manufacture according to claim 3, wherein the useful fluid further comprising sunscreen lotion, body lotion, and first aid liquids.

5. The article of manufacture according to claim 1, wherein the wearable container case may be shaped to represent an animal, and treats

6. The article of manufacture according to claim 5, wherein the animal comprises a teddy bear, puppy, kitten, and bird; and the treats comprise cookies, stars, sea creatures, and cartoon characters.

7. The article of manufacture according to claim 2, wherein the electronic watch assembly comprises a smart watch capable of communicating with a mobile device.

8. The article of manufacture according to claim 7, wherein the electronic watch assembly comprises cellular network communications circuitry.

9. The article of manufacture according to claim 2, wherein the electronic watch assembly comprises an electronic display for presenting digital images to the user.

10. The article of manufacture according to claim 9, wherein the electronic display further presents digital notification messages and information to the user.
